(19) United States
(12) Patent Application Publication
(10) Pub. No.: US 2017/0213516 A1
(43) Pub. Date: Jul. 27, 2017

(54) GATE DRIVE CIRCUIT AND LIQUID CRYSTAL DISPLAY

(71) Applicant: Wuhan China Star Optoelectronics Technology Co., Ltd., Wuhan (CN)

(72) Inventors: Shangcao CAO, Shenzhen (CN); Qiang GONG, Shenzhen (CN)

(73) Assignee: Wuhan China Star Optoelectronics Technology Co., Ltd., Wuhan (CN)

(21) Appl. No.: 15/079,512

(22) Filed: Mar. 24, 2016

(30) Foreign Application Priority Data
Jan. 25, 2016 (CN) 2016100494250

(51) Int. Cl. G09G 3/36

(52) U.S. Cl. CPC G09G 3/3685; G09G 2310/0286

(57) ABSTRACT

The present disclosure discloses a gate drive circuit and a liquid crystal display, the gate drive circuit includes a shift register circuit, a display circuit and an adjust circuit connected mutually; the shift register circuit is applied to output a first control signal during scanning to turn on each pixel switch in the display circuit to charge each pixel; the adjust circuit is applied to send a second control signal after charging the pixels, turning off each pixel switch in the display circuit to discontinue charging of each pixel. By the method above, pixel switches can be turned off in time after scanning, which reduces the risk of signal mischarge.

### FIELD OF THE DISCLOSURE

The present disclosure relates to a drive circuit technology field, and more particularly to a gate drive circuit and a liquid crystal display.

### BACKGROUND OF THE DISCLOSURE

A gate driver on array (GOA) is disposing a gate array scanning drive circuit on an array substrate by a conventional thin film transistor liquid crystal display array process to achieve drive of scanning each line of the gate.

With the increasing demand of resolution, a constant charging rate without decreasing the opening rate needs a shorter delay of a scanning drive signal, which can ensure a charging ratio of a pixel. After charging, scanning lines stop receiving scanning signals, but as the resolution is high, scanning lines and multiple pixel capacitors form a RC delay, the electric potential is hard to be reduced rapidly, which means a pixel switch cannot be turned off rapidly, leading to the mischarge of data signals of other lines to the line.

### SUMMARY OF THE DISCLOSURE

The technical issue that the embodiment of the present disclosure solves is to provide a gate drive circuit and a liquid crystal display, which can turn off pixel switches in time after scanning, reducing the risk of signals mischarge.

A proposal of the present disclosure to solve the technical problem above is: providing a gate drive circuit, the gate drive circuit includes a shift register circuit, a display circuit and an adjust circuit connected by a scanning line electrically; the shift register circuit is applied to send a first control signal to one end of the scanning line, turning on each pixel switch in the display circuit to charge each pixel; the adjust circuit is applied to send a second control signal to the other end of the scanning line after charging the pixels, turning off each pixel switch in the display circuit to discontinue charging of each pixel.

The display circuit is disposed on a display region of a display screen connected with the gate drive circuit; in two adjacent levels of gate drive circuits, the shift register circuit and the adjacent circuit are disposed alternately on two opposite sides of the display region of the display screen connected with the gate drive circuit respectively.

N is defined as a positive integer, in a Nth level gate drive circuit unit, the adjust circuit includes a key pull-down circuit, the key pull-down circuit includes a first switch tube and a second switch tube; a control terminal of the first switch tube receives transmission signal from the shift register circuit in a (N−1)th level gate drive circuit, an input terminal of which receives the second control signal and an output terminal of which is connected with the N levels of scanning lines; a control terminal of the second switch tube receives transmission signal from the shift register circuit in a (N+1)th level gate drive circuit, an input terminal of which receives the second control signal and an output terminal of which is connected with the N levels of scanning lines.

In the Nth level gate drive circuit, the shift register circuit includes a Nth level pull-up control circuit, a Nth level pull-up circuit, a Nth level pull-down control circuit and a Nth level pull-down circuit; the Nth level pull-up control circuit and the Nth level pull-up circuit are connected to a first common point, applied to control a switch of the Nth level pull-up circuit; the Nth level pull-up circuit is connected to the Nth scanning line, applied to send scanning signals and transmission signal during scanning; a first terminal of the Nth level pull-down control circuit is connected to the first common point, a second terminal and the first terminal of the Nth pull-down control circuit are connected to a second common point, applied to control a switch of the Nth level pull-down circuit; a second terminal of the Nth level pull-down circuit is connected to the Nth level pull-up circuit, applied to pull down electric potentials of the scanning signals and the transmission signal after scanning.

The Nth level pull-up control circuit includes a third switch tube and a fourth switch tube; a control terminal of the third switch tube receives a (N−2)th level transmission signal, an input terminal of which receives the first control signal during scanning in a forward direction, and receives the second control signal during scanning in a reverse direction, the input terminal is connected to the first common point; a control terminal of the fourth switch tube receives a (N+2)th level transmission signal, an input terminal of which receives the second control signal during scanning in a forward direction, and receives the first control signal during scanning in a reverse direction, the input terminal is connected to the first common point.

The Nth level pull-up control circuit includes a fifth switch tube and a sixth switch tube; a control terminal of the fifth switch tube is connected to the first common point, an input terminal of which receives a Nth level clock signal and an output terminal of which outputs a Nth level transmission signal; a control terminal of the sixth switch tube is connected to the first common point, an input terminal of which receives a Nth level clock signal and an output terminal of which outputs a Nth leveled transmission signal.

The Nth level pull-down control circuit includes a seventh switch tube, an eighth switch tube and a ninth switch tube; a control terminal of the seventh switch tube is connected to the first common point, an input terminal of which receives the second control signal; a control terminal of the eighth switch tube is connected to the output terminal of the seventh switch tube and receiving a (N+1)th level clock signal, an input terminal of which receives the first control signal and an output terminal of which is connected with the second common point; a control terminal of the ninth switch tube is connected to the first common point, an input terminal of which receives the second control signal and an output terminal of which is connected to the second common point.

A duty ratio of the Nth level clock signal and the (N+1)th level clock signal is 25%, the (N+1)th level clock signal is postponed a fourth cycle compared with the Nth level clock signal.

The Nth level pull-down control circuit includes a tenth switch tube and an eleventh switch tube; a control terminal of the tenth switch tube is connected to the second common point, an input terminal of which receives the second control signal and an output terminal of which is connected with the output terminal of the fifth switch tube; a control terminal of the eleventh switch tube is connected to the second common point, an input terminal of which receives the second control signal and an output terminal of which is connected with the output terminal of the sixth switch tube.

To solve the technical problem above, another proposal of the disclosure is: providing a liquid crystal display, the display includes a plurality of gate drive circuits disposed with levels connection described above.

Merits of the disclosure: distinguishing from a conventional technique, according to the disclosure, after scanning a line of pixels and charging each pixels, control signals of low electric potential are input from two sides of the scanning line pulling down scanning signals to be low electric potential and turning off pixel switches in each pixel rapidly to discontinue the charge of each pixel. In doing so pixel switches can be turned off in time after scanning a line of pixels, preventing mischarge of data signals in the line of pixels during scanning other lines, which can improve quality of an image.

### BRIEF DESCRIPTION OF THE DRAWINGS

FIG. 1 is a structural diagram of a gate drive circuit according to a first embodiment of the present disclosure;

FIG. 2 is a comparison diagram of a scanning signal of the gate drive circuit in the first embodiment of the disclosure and a scanning signal in a conventional technique;

FIG. 3 is a circuit diagram of a key pull-down circuit in a gate drive circuit according to a second embodiment of the disclosure;

FIG. 4 is a diagram of scanning signals in the gate drive circuit according to the second embodiment of the disclosure;

FIG. 5 is a circuit structural diagram of a shift register circuit in a gate drive circuit according to a third embodiment of the disclosure;

FIG. 6 is a circuit diagram of the shift register circuit in the gate drive circuit according to the third embodiment of the disclosure;

FIG. 7 is a sequence chart of the shift register circuit in the gate drive circuit according to the third embodiment of the disclosure;

FIG. 8 is a structural diagram of a liquid crystal display according to an embodiment of the disclosure;

FIG. 9 is a circuit structural diagram of the liquid crystal display according to the embodiment of the disclosure.

### DETAILED DESCRIPTION OF PREFERRED EMBODIMENTS

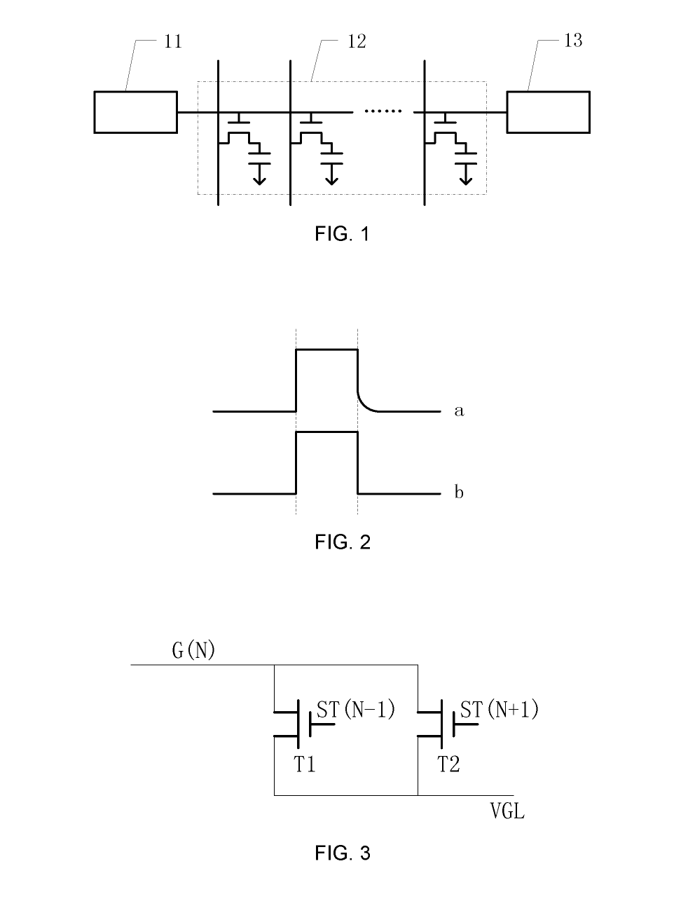

Referring to FIG. 1, a structural diagram of a gate drive circuit according to a first embodiment of the present disclosure, a gate drive circuit includes a shift register circuit 11, a display circuit 12 and an adjust circuit 13 connected by a scanning line electrically.

The shift register circuit 11 is applied to send a first control signal to the scanning line, turning on each pixel switch in the display circuit 12 to charge each pixel.

The adjust circuit 13 is applied to send a second control signal to the scanning line after charging the pixels, turning off each pixel switch in the display circuit 12 to discontinue charging of each pixel.

The proposal of the embodiment is illustrated by taking a N type pixel switch TFT as an example:

Referring to FIG. 2, a is a waveform of a scanning signal without the adjust circuit 13, b is a waveform of a scanning signal with the adjust circuit 13 in the embodiment.

Referring to the curve a, in a conventional technique, the shift register circuit 11 inputs a first control signal with high electric potential to the scanning line, in order to raise a scanning signal to be high electric potential, each pixel switch in the display circuit 12 is turned on, a data line charges a pixel electrode. After charging, the shift register circuit 11 inputs a low electric potential control signal to an end of the scanning line, in order to pull down a scanning signal to be a low electric potential, each pixel switch in the display circuit 12 is turned off, the pixel electrodes are charged. Since the RC delay caused by the scanning line in the display circuit 12 and multiple pixel electrodes, the low electric potential control signal cannot drop the scanning signal immediately, therefore, a scanning signal slowdown as in the curve a is formed. If other lines start to be scanned and the present line has not been turned off, data signals can be mischarged into the present line, which can reduce the quality of a display image.

Referring to a curve b, in the embodiment, the shift register circuit 11 inputs a first control signal with high electric potential to the scanning line, in order to raise the scanning signal to be high electric potential, each pixel switch in the display circuit 12 is turned on, the data line charges pixel electrodes. After charging, the shift register circuit 11 inputs a control signal with low electric potential to one end of the scanning line and simultaneously the adjust circuit 13 inputs a second control signal with low electric potential to the other end of the scanning line, in order to drop the scanning signal rapidly to be low electric potential, each pixel switch in the display circuit 12 is turned off rapidly, the pixel electrodes are charged.

Distinguishing from a conventional technique, according to the embodiment, after a line of pixels are scanned and each pixel is charged, the control signal with low electric potential is input through two ends of the scanning line to drop the scanning signal to be low electric potential, a pixel switch in each pixel is turned off rapidly to discontinue charging of each pixel. In doing so, pixel switches can be turned off immediately after a line of pixels are scanned, no mischarge of data signals into the present line of pixels during scanning other lines, improving the quality of an image.

Referring to FIG. 3, a circuit diagram of a key pull-down circuit in a gate drive circuit according to a second embodiment of the disclosure, the circuit includes a shift register circuit, a display circuit and an adjust circuit connected by a scanning line electrically.

The display circuit is disposed on a display region of a display screen connected with the gate drive circuit; in two adjacent levels of gate drive circuits, the shift register circuit and the adjacent circuit are disposed alternately on two opposite sides of the display region of the display screen connected with the gate drive circuit respectively.

Specifically, the gate drive circuit controls a scanning signal of a scanning line, each gate drive circuit is initiated by a plurality of control signals or clock signals from other lines of gate drive circuits, taking a Nth level gate drive circuit as an example:

In a Nth level gate drive circuit unit, the adjust circuit includes a key pull-down circuit, the key pull-down circuit includes a first switch tube T1 and a second switch tube T2.

A control terminal of the first switch tube T1 receives transmission signal ST(N−1) from the shift register circuit in a (N−1)th level gate drive circuit, an input terminal of which receives the second control signal VGL and an output terminal of which is connected with the N levels of scanning lines.

A control terminal of the second switch tube T2 receives transmission signalST(N+1) from the shift register circuit in a (N+1)th level gate drive circuit, an input terminal of which receives the second control signal VGL and an output terminal of which is connected with the N levels of scanning lines.

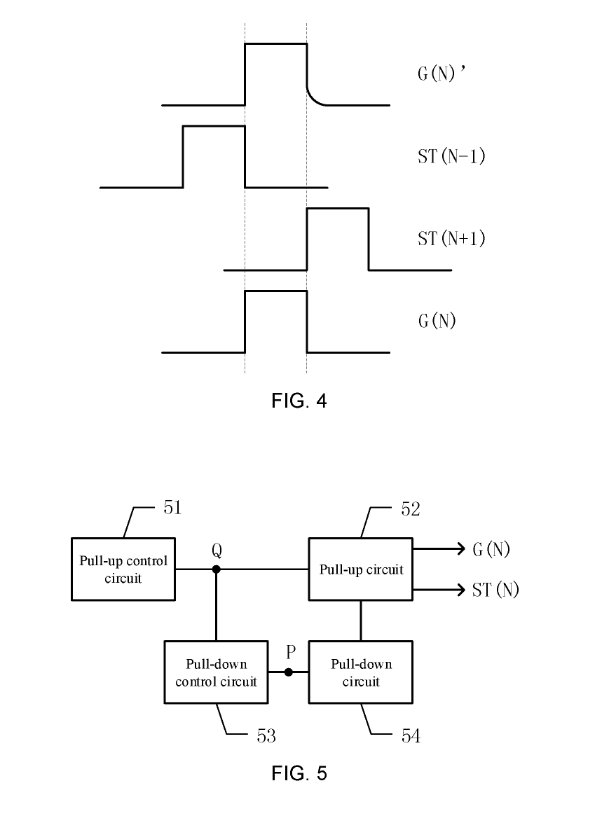

Referring to FIG. 4 simultaneously, a diagram of scanning signals in the gate drive circuit according to the second embodiment of the disclosure, G(N)′ is a scanning signal waveform in a conventional technique.

FIG. 4 shows a rapid falling scanning signal G(N) of a scanning line during scanning in a forward direction, when the next level−(N+1)th level transmission signal ST(N+1) is a high electric potential signal, the second switch tube T2 is turned on, an input terminal of the second switch tube T2 receives the low electric potential second control signal VGL.

During scanning in a reverse direction, when the last level−(N−1)th level transmission signal ST(N−1) is a high electric potential signal, the first switch tube T1 is turned on, an input terminal of the first switch tube T1 receives the low electric potential second control signal VGL, which pulls down the scanning signal G(N) of the scanning line rapidly.

Referring to FIG. 5, a circuit structural diagram of a shift register circuit in a gate drive circuit according to a third embodiment of the disclosure, the circuit includes a shift register circuit, a display circuit and an adjust circuit connected by a scanning line electrically.

In the Nth level gate drive circuit, the shift register circuit includes a Nth level pull-up control circuit 51, a Nth level pull-up circuit 52, a Nth level pull-down control circuit 53 and a Nth level pull-down circuit 54.

The Nth level pull-up control circuit 51 and the Nth level pull-up circuit 52 are connected to a first common point Q, applied to control a switch of the Nth level pull-up circuit 52.

The Nth level pull-up circuit 52 is connected to the Nth scanning line, applied to send scanning signals G(N) and transmission signal ST(N) during scanning.

A first terminal of the Nth level pull-down control circuit 53 is connected to the first common point Q, a second terminal and the first terminal of the Nth pull-down control circuit 54 are connected to a second common point P, applied to control a switch of the Nth level pull-down circuit 54.

A second terminal of the Nth level pull-down circuit 54 is connected to the Nth level pull-up circuit 52, applied to pull down electric potentials of the scanning signals G(N) and the transmission signal ST(N) after scanning.

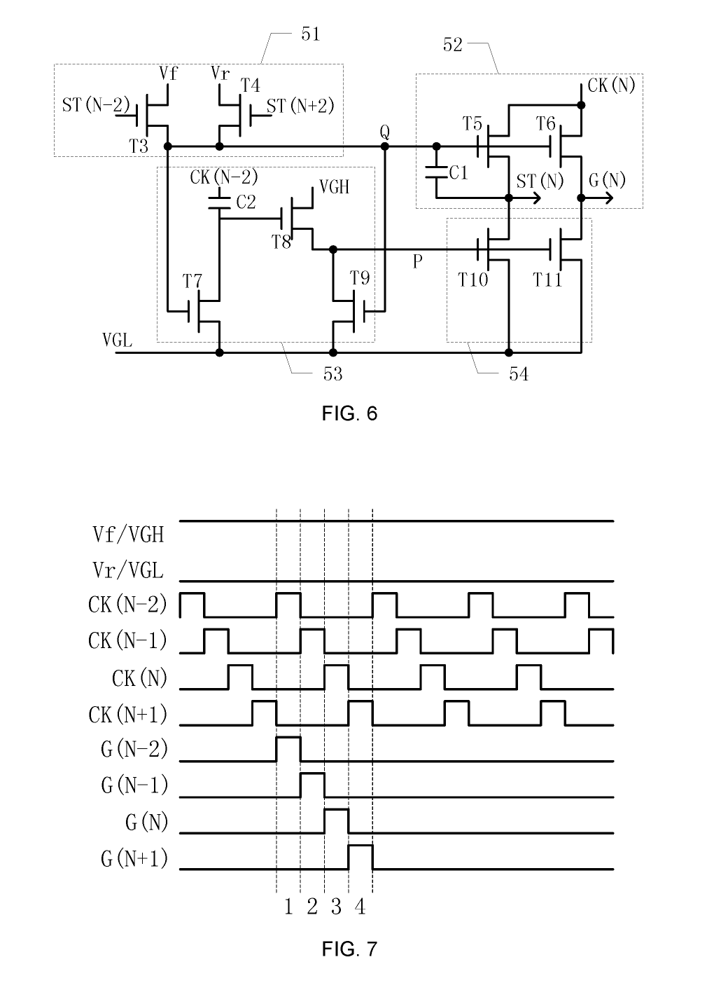

Specifically, referring to FIG. 6, a circuit diagram of the shift register circuit in the gate drive circuit according to the third embodiment of the disclosure.

In following circuit connections, the first control signal is a high electric potential signal VGH, the second control signal is a low electric potential signal VGL.

The Nth level pull-up control circuit 51 includes a third switch tube T3 and a fourth switch tube T4; a control terminal of the third switch tube T3 receives a (N−2)th level transmission signal ST(N−2), an input terminal of which receives the first control signal VGH during scanning in a forward direction, and receives the second control signal VGL during scanning in a reverse direction, the input terminal is connected to the first common point Q; a control terminal of the fourth switch tube T4 receives a (N+2)th level transmission signal, an input terminal of which receives the second control signal VGL during scanning in a forward direction, and receives the first control signal VGH during scanning in a reverse direction, the input terminal is connected to the first common point Q.

Optionally, the input terminal of the third switch tube T3 receives a clock signal Vf, the input terminal of the fourth switch tube T4 receives a clock signal Vr. The clock signal Vf is high electric potential during scanning in a forward direction and low electric potential during scanning in a reverse direction; the clock signal Vr is low electric potential during scanning in a forward direction and high electric potential during scanning in a reverse direction.

The Nth level pull-up control circuit 52 includes a fifth switch tube T5 and a sixth switch tube T6; a control terminal of the fifth switch tube T5 is connected to the first common point Q, an input terminal of which receives a Nth level clock signal CK(N) and an output terminal of which outputs a Nth level transmission signal ST(N); a control terminal of the sixth switch tube T6 is connected to the first common point Q, an input terminal of which receives a Nth level clock signal CK(N) and an output terminal of which outputs a Nth level transmission signal G(N).

Optionally, the Nth level pull-up circuit 52 further includes a first capacitor C1, a first end of which is connected to the first common point Q, and a second end is connected to an output terminal of the fifth transistor T5.

The Nth level pull-down control circuit 53 includes a seventh switch tube T7, an eighth switch tube T8 and a ninth switch tube T9; a control terminal of the seventh switch tube T7 is connected to the first common point Q, an input terminal of which receives the second control signal VGL; a control terminal of the eighth switch tube T8 is connected to the output terminal of the seventh switch tube T7 and receiving a (N−2)th level clock signal CK(N−2), an input terminal of which receives the first control signal VGH and an output terminal of which is connected with the second common point P; a control terminal of the ninth switch tube T9 is connected to the first common point Q, an input terminal of which receives the second control signal VGL and an output terminal of which is connected to the second common point P.

Optionally, the Nth level pull-down control circuit 53 further includes a second capacitor C2, a first terminal of which receives the (N−2)th level clock signal CK(N−2), the second terminal is connected with the control terminal of the eighth transistor T8.

The Nth level pull-down control circuit 54 includes a tenth switch tube T10 and an eleventh switch tube T11; a control terminal of the tenth switch tube T10 is connected to the second common point P, an input terminal of which receives the second control signal VGL and an output terminal of which is connected with the output terminal of the fifth switch tube T5; a control terminal of the eleventh switch tube T11 is connected to the second common point P, an input terminal of which receives the second control signal VGL and an output terminal of which is connected with the output terminal of the sixth switch tube T6.

Referring to FIG. 7, circuits of the disclosure is illustrated in detail by taking scanning in a forward direction as an example:

A duty ratio of each level of clock signals is 25%, each clock signal is postponed a fourth cycle compared with the last level, for instance, the (N+1)th level clock signal is postponed a fourth cycle compared with the Nth level clock signal. Meanwhile, since the transmission signal ST and the scanning signal G have similar sequences, therefore, the transmission signal is absent in figures, which can be referred to scanning signals of the same level.

A first function scale: the (N−2)th level transmission signal ST(N−2) is high electric potential, the third transistor T3 is turned on, the high electric potential signal Vf raises electric potential of the first common point Q to high electric potential, the fifth transistor T5 and the sixth transistor T6 are turned on. At this time, the Nth level clock signal CK(N) is low electric potential, therefore, the output Nth level transmission signal ST(N) and the Nth level scanning signal G(N) are both low electric potential signals.

A second function scale: the (N−2)th level transmission signal ST(N−2) is low electric potential, the third transistor T3 is turned on, the high electric potential signal Vf raises electric potential of the first common point Q to high electric potential, the fifth transistor T5 and the sixth transistor T6 are turned on. At this time, the Nth level clock signal CK(N) is low electric potential, therefore, the output Nth level transmission signal ST(N) and the Nth level scanning signal G(N) are both low electric potential signals.

A third function scale: the (N−2)th level transmission signal ST(N−2) is low electric potential, the third transistor T3 is turned off, the Q point is remaining high electric potential, the fifth transistor T5 and the sixth transistor T6 are turned on. At this time, the Nth level clock signal CK(N) is high electric potential, therefore, the output Nth level transmission signal ST(N) and the Nth level scanning signal G(N) are high electric potential signals, which scan the line of pixels. Meanwhile, as coupling effect of the first capacitor C1, the electric potential of the first common point Q is ensured to be high electric potential further, assuring stable output.

A fourth function scale: the (N+1)th level clock signal CK(N+1) turns to be high electric potential, the eighth transistor T8 is turned on, the high electric potential first control signal VGH raises electric potential of the second common point P to turn on the tenth transistor T10 and the eleventh transistor T11, the low electric potential second control signal VGL pulls down electric potential of the first common point Q, the fifth transistor T5 and the sixth transistor T6 are turned off, output is stopped.

Transmission directions of signals and variation of electric potential above are merely formed under the circumstances of one clock signal diversification, clock signals in other embodiments can be adjusted to obtain the effect as the embodiment.

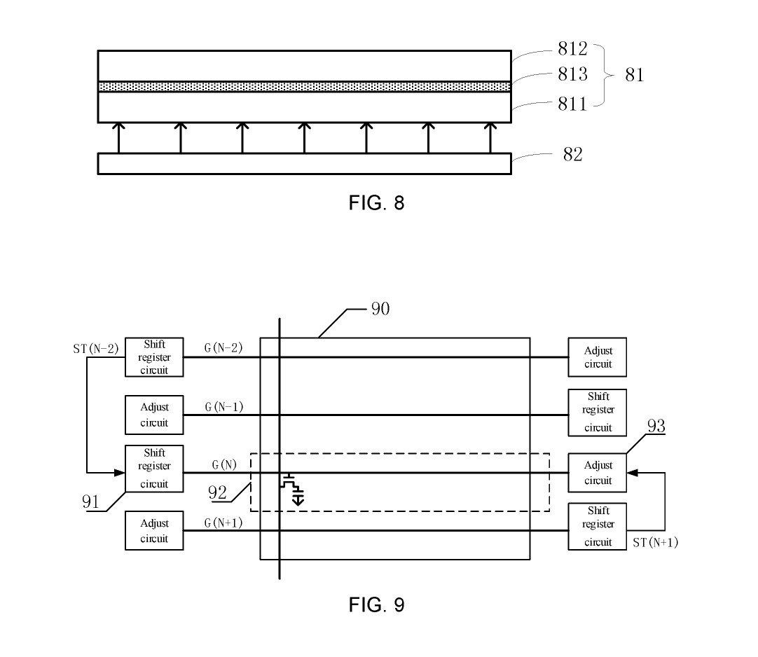

Referring to FIG. 8, a structural diagram of a liquid crystal display according to an embodiment of the disclosure, the liquid crystal display includes a display panel 81 and a backlight 82, the display panel 81 includes an array substrate 811, a color film substrate 812, a liquid crystal layer 813 disposed between the array substrate 811 and the color film substrate 812.

Specifically, the array substrate 811 includes a plurality of gate drive circuits disposed with levels connection.

Referring to FIG. 9, taking the Nth level gate drive circuit as an example, a gate drive circuit includes a shift register circuit 91, a display circuit 92 and an adjust circuit 93.

The display circuit 92 is disposed on a display region 90 of a display screen connected with the gate drive circuit; in two adjacent levels of gate drive circuits, the shift register circuit and the adjacent circuit are disposed alternately on two opposite sides of the display region of the display screen connected with the gate drive circuit respectively.

The shift register circuit 91, the display circuit 92 and the adjust circuit 93 are circuits as in the embodiments above which can be referred, hence more description is glossed over.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A gate drive circuit, wherein the gate drive circuit comprises a shift register circuit, a display circuit and an adjust circuit connected by a scanning line electrically;
the shift register circuit applied to send a first control signal to one end of the scanning line, turning on each pixel switch in the display circuit, in order to charge each pixel;
the adjust circuit applied to send a second control signal to the other end of the scanning line after the pixels are fully charged, turning off each pixel switch in the display circuit, in order to discontinue charging of each pixel.

2. The gate drive circuit according to claim 1, wherein the display circuit is disposed on a display region of a display screen connected with the gate drive circuit;
in two adjacent levels of gate drive circuits, the shift register circuit and the adjacent circuit disposed alternately on two opposite sides of the display region of the display screen connected with the gate drive circuit respectively.

3. The gate drive circuit according to claim 1, wherein N is defined as a positive integer, in a Nth level gate drive circuit unit, the adjust circuit comprises a key pull-down circuit, the key pull-down circuit comprises a first switch tube and a second switch tube;
a control terminal of the first switch tube receiving transmission signals from a shift register circuit in a (N−1)th level gate drive circuit, an input terminal of which receiving the second control signal and an output terminal of which connected with N levels of scanning lines;
a control terminal of the second switch tube receiving transmission signals from a shift register circuit in a (N+1)th level gate drive circuit, an input terminal of which receiving the second control signal and an output terminal of which connected with N levels of scanning lines.

4. The gate drive circuit according to claim 3, wherein in the Nth level gate drive circuit, the shift register circuit comprises a Nth level pull-up control circuit, a Nth level pull-up circuit, a Nth level pull-down control circuit and a Nth level pull-down circuit;
the Nth level pull-up control circuit and the Nth level pull-up circuit connected to a first common point, applied to control a switch of the Nth level pull-up circuit;
the Nth level pull-up circuit connected to the Nth scanning line, applied to output scanning signals and transmission signals during scanning;
a first terminal of the Nth level pull-down control circuit connected to the first common point, a second terminal and a first terminal of the Nth pull-down circuit connected to a second common point, applied to control a switch of the Nth level pull-down circuit;
a second terminal of the Nth level pull-down circuit connected to the Nth level pull-up circuit, applied to pull down electric potentials of the scanning signals and the transmission signals after scanning.

5. The gate drive circuit according to claim 4, wherein the Nth level pull-up control circuit comprises a third switch tube and a fourth switch tube;
a control terminal of the third switch tube receiving a (N−2)th level transmission signal, an input terminal of which receiving the first control signal during scanning in a forward direction, and receiving the second control signal during scanning in a reverse direction, the input terminal connected to the first common point;
a control terminal of the fourth switch tube receiving a (N+2)th level transmission signal, an input terminal of which receiving the second control signal during scanning in a forward direction, and receiving the first control signal during scanning in a reverse direction, the input terminal connected to the first common point.

6. The gate drive circuit according to claim 5, wherein the Nth level pull-up circuit comprises a fifth switch tube and a sixth switch tube;
a control terminal of the fifth switch tube connected to the first common point, an input terminal of which receiving a Nth level clock signal and an output terminal of which outputting a Nth level transmission signal;
a control terminal of the sixth switch tube connected to the first common point, an input terminal of which receiving the Nth level clock signal and an output terminal of which outputting a Nth level scanning signal.

7. The gate drive circuit according to claim 6, wherein the Nth level pull-down control circuit comprises a seventh switch tube, an eighth switch tube and a ninth switch tube;
a control terminal of the seventh switch tube connected to the first common point, an input terminal of which receiving the second control signal;
a control terminal of the eighth switch tube connected to the output terminal of the seventh switch tube and receiving a (N+1)th level clock signal, an input terminal of which receiving the first control signal and an output terminal of which connected with the second common point;
a control terminal of the ninth switch tube connected to the first common point, an input terminal of which receiving the second control signal and an output terminal of which connected to the second common point.

8. The gate drive circuit according to claim 7, wherein a duty ratio of the Nth level clock signal and the (N+1)th level clock signal is 25%, the (N+1)th level clock signal is postponed a fourth cycle compared with the Nth level clock signal.

9. The gate drive circuit according to claim 7, wherein the Nth level pull-down circuit comprises a tenth switch tube and an eleventh switch tube;
a control terminal of the tenth switch tube connected to the second common point, an input terminal of which receiving the second control signal and an output terminal of which connected with the output terminal of the fifth switch tube;
a control terminal of the eleventh switch tube connected to the second common point, an input terminal of which receiving the second control signal and an output terminal of which connected with the output terminal of the sixth switch tube.

10. A liquid crystal display, wherein the display comprises a plurality of gate drive circuits disposed with levels connection, the gate drive circuit comprises a shift register circuit, a display circuit and an adjust circuit connected by a scanning line electrically; the shift register circuit is applied to send a first control signal to one end of the scanning line, turning on each pixel switch in the display circuit to charge each pixel; the adjust circuit is applied to send a second control signal to the other end of the scanning line after charging the pixels, turning off each pixel switch in the display circuit to discontinue charging of each pixel.

11. The liquid crystal display according to claim 10, wherein the display circuit is disposed on a display region of a display screen connected with the gate drive circuit; in two adjacent levels of gate drive circuits, the shift register circuit and the adjacent circuit are disposed alternately on two opposite sides of the display region of the display screen connected with the gate drive circuit respectively.

12. The liquid crystal display according to claim 10, wherein N is defined as a positive integer, in a Nth level gate drive circuit unit, the adjust circuit comprises a key pull-down circuit, the key pull-down circuit comprises a first switch tube and a second switch tube; a control terminal of the first switch tube receives transmission signals from the shift register circuit in a (N−1)th level gate drive circuit, an input terminal of which receives the second control signal and an output terminal of which is connected with the N levels of scanning lines; a control terminal of the second switch tube receives transmission signals from the shift register circuit in a (N+1)th level gate drive circuit, an input terminal of which receives the second control signal and an output terminal of which is connected with the N levels of scanning lines.

13. The liquid crystal display according to claim 12, wherein in the Nth level gate drive circuit, the shift register circuit comprises a Nth level pull-up control circuit, a Nth level pull-up circuit, a Nth level pull-down control circuit and a Nth level pull-down circuit; the Nth level pull-up control circuit and the Nth level pull-up circuit are connected to a first common point, applied to control a switch of the Nth level pull-up circuit; the Nth level pull-up circuit is connected to the Nth scanning line, applied to send scanning signals and transmission signals during scanning; a first terminal of the Nth level pull-down control circuit is connected to the first common point, a second terminal and the first terminal of the Nth pull-down control circuit are connected to a second common point, applied to control a switch of the Nth level pull-down circuit; a second terminal of the Nth level pull-down circuit is connected to the Nth level pull-up circuit, applied to pull down electric potentials of the scanning signals and the transmission signals after scanning.

14. The liquid crystal display according to claim 13, wherein the Nth level pull-up control circuit comprises a third switch tube and a fourth switch tube; a control terminal of the third switch tube receives a (N−2)th level transmission signal, an input terminal of which receives the first control signal during scanning in a forward direction, and receives the second control signal during scanning in a reverse direction, the input terminal is connected to the first common point; a control terminal of the fourth switch tube receives a (N+2)th level transmission signal, an input terminal of which receives the second control signal during scanning in a forward direction, and receives the first control signal during scanning in a reverse direction, the input terminal is connected to the first common point.

15. The liquid crystal display according to claim 14, wherein the Nth level pull-up circuit comprises a fifth switch tube and a sixth switch tube; a control terminal of the fifth switch tube is connected to the first common point, an input terminal of which receives a Nth level clock signal and an output terminal of which outputs a Nth level transmission signal; a control terminal of the sixth switch tube is connected to the first common point, an input terminal of which receives a Nth level clock signal and an output terminal of which outputs a Nth level transmission signal.

16. The liquid crystal display according to claim 15, wherein the Nth level pull-down control circuit comprises a seventh switch tube, an eighth switch tube and a ninth switch tube; a control terminal of the seventh switch tube is connected to the first common point, an input terminal of which receives the second control signal; a control terminal of the eighth switch tube is connected to the output terminal of the seventh switch tube and receiving a (N+1)th level clock signal, an input terminal of which receives the first control signal and an output terminal of which is connected with the second common point; a control terminal of the ninth switch tube is connected to the first common point, an input terminal of which receives the second control signal and an output terminal of which is connected to the second common point.

17. The liquid crystal display according to claim 16, wherein a duty ratio of the Nth level clock signal and the (N+1)th level clock signal is 25%, the (N+1)th level clock signal is postponed a fourth cycle compared with the Nth level clock signal.

18. The liquid crystal display according to claim 16, wherein the Nth level pull-down circuit comprises a tenth switch tube and an eleventh switch tube; a control terminal of the tenth switch tube is connected to the second common point, an input terminal of which receives the second control signal and an output terminal of which is connected with the output terminal of the fifth switch tube; a control terminal of the eleventh switch tube is connected to the second common point, an input terminal of which receives the second control signal and an output terminal of which is connected with the output terminal of the sixth switch tube.
